(19) United States
(12) Patent Application Publication
(10) Pub. No.: US 2014/0313664 A1
(43) Pub. Date: Oct. 23, 2014

(54) FOLDING ELECTRONIC DEVICE HAVING STABILITY FUNCTION

(71) Applicant: HON HAI PRECISION INDUSTRY CO., LTD., New Taipei (TW)

(72) Inventors: KUO-HSIANG WU, New Taipei (TW); KUAN-YU CHEN, New Taipei, PA (US)

(73) Assignee: HON HAI PRECISION INDUSTRY CO., LTD., New Taipei (TW)

(21) Appl. No.: 14/255,013

(22) Filed: Apr. 17, 2014

(30) Foreign Application Priority Data
Apr. 19, 2013 (TW) 102114095

(51) Int. Cl. G06F 1/16

(52) U.S. Cl. CPC G06F 1/1675
USPC 361/679.55; 312/223.1

(57) ABSTRACT

A folding electronic with protection against an opened cover pulling it over backwards has a base which includes at least one ejecting structure. A stability plate is fixed on the ejecting structure. When the cover is opened relative to the base, the stability plate extends from the base to provide additional support for the folding electronic device.

### FIELD

The present disclosure relates to electronic devices, and particularly to a folding electronic device having a stability function.

### BACKGROUND

A notebook may include a base and a cover capable of being opened and closed relative to the base.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the three views.

FIG. 1 is a perspective view of a folding electronic device in a closed state.

FIG. 2 is a perspective view of the folding electronic device of FIG. 1 in an open state.

FIG. 3 is similar to FIG. 2, but viewed from another angle.

FIG. 4 is an exploded perspective view of a base, an ejecting structure, and a stability plate of the folding electronic device of FIG. 2.

FIG. 5 is a partially enlarged perspective view of FIG. 4.

FIG. 6 is similar to FIG. 5, but viewed from another angle.

FIG. 7 is an assembled perspective view of the structures of FIG. 5.

FIG. 8 is similar to FIG. 7, but showing the stability plate ejected.

FIG. 9 is a perspective view showing the stability plate extended out of the base.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

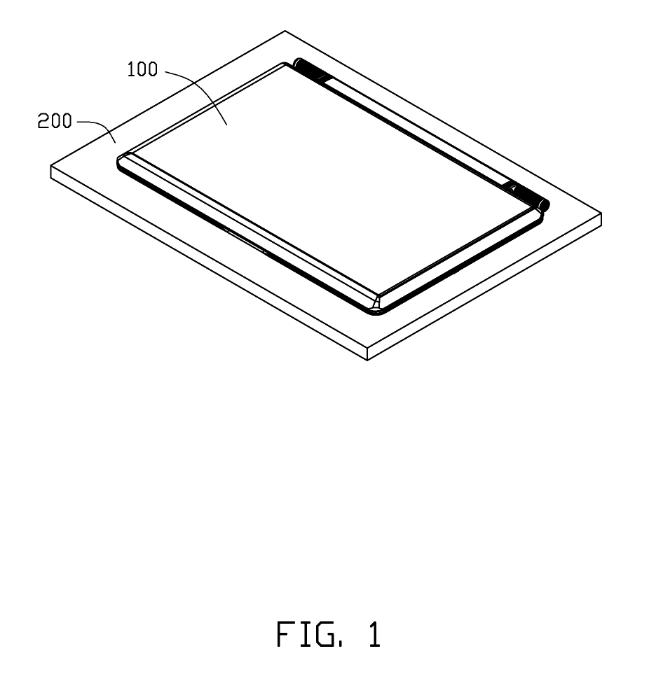

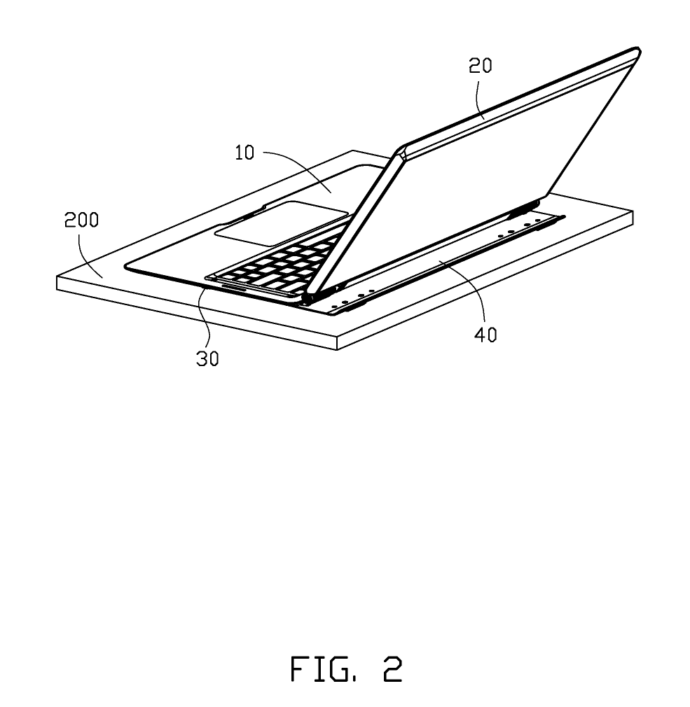

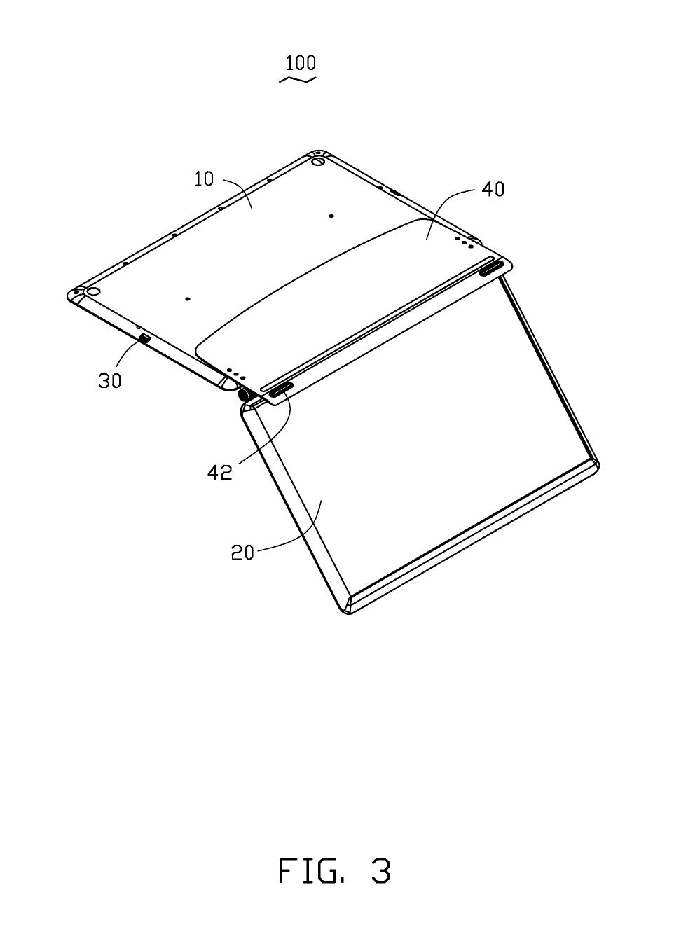

Referring to FIGS. 1-3, a folding electronic device 100 is on a supporting surface 200. The folding electronic device 100 includes a base 10, a cover 20, and a stability plate 40. The cover 20 can be coupled to the base 10, and capable of being opened and closed relative to the base 10. The base 10 comprises at least one ejecting structure 30. The stability plate 40 is fixed to the ejecting structure 30. When the cover 20 is opened relative to the base 10, the stability plate 40 is extended from the base 10 by the ejecting structure 30 to lend additional support and stability to the folding electronic device 100, to prevent the base 10 from being overbalanced by the cover 20. In the embodiment, the folding electronic device 100 is a notebook or other folding device.

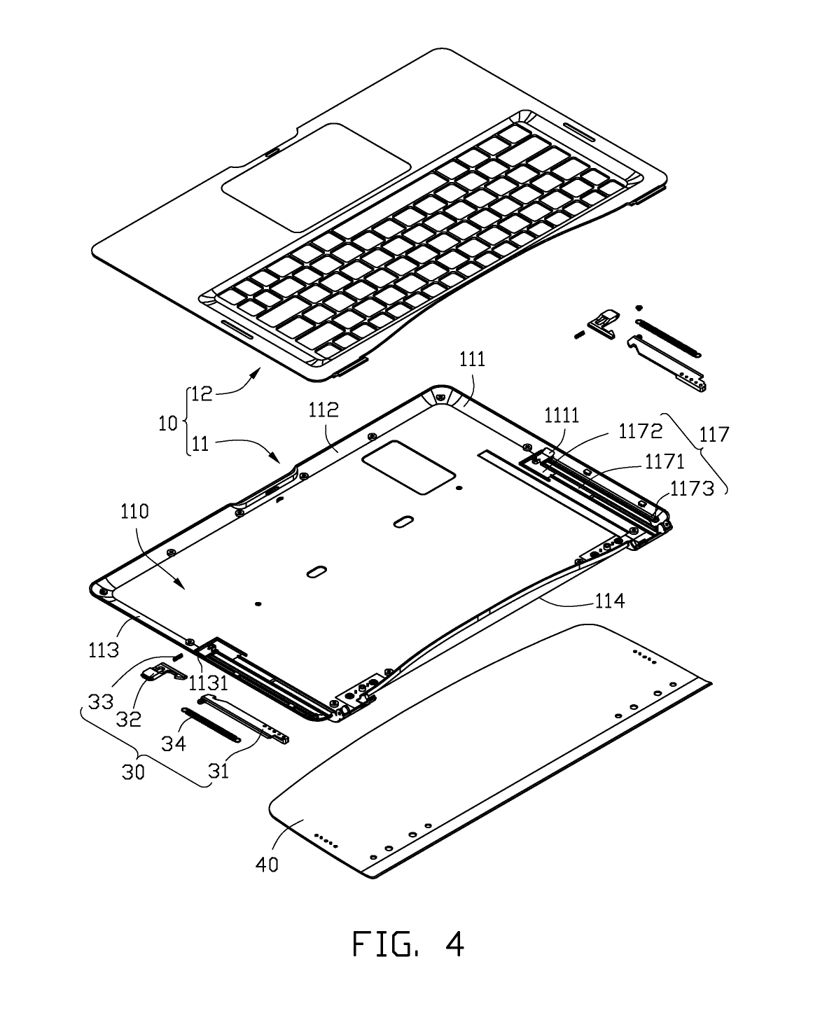

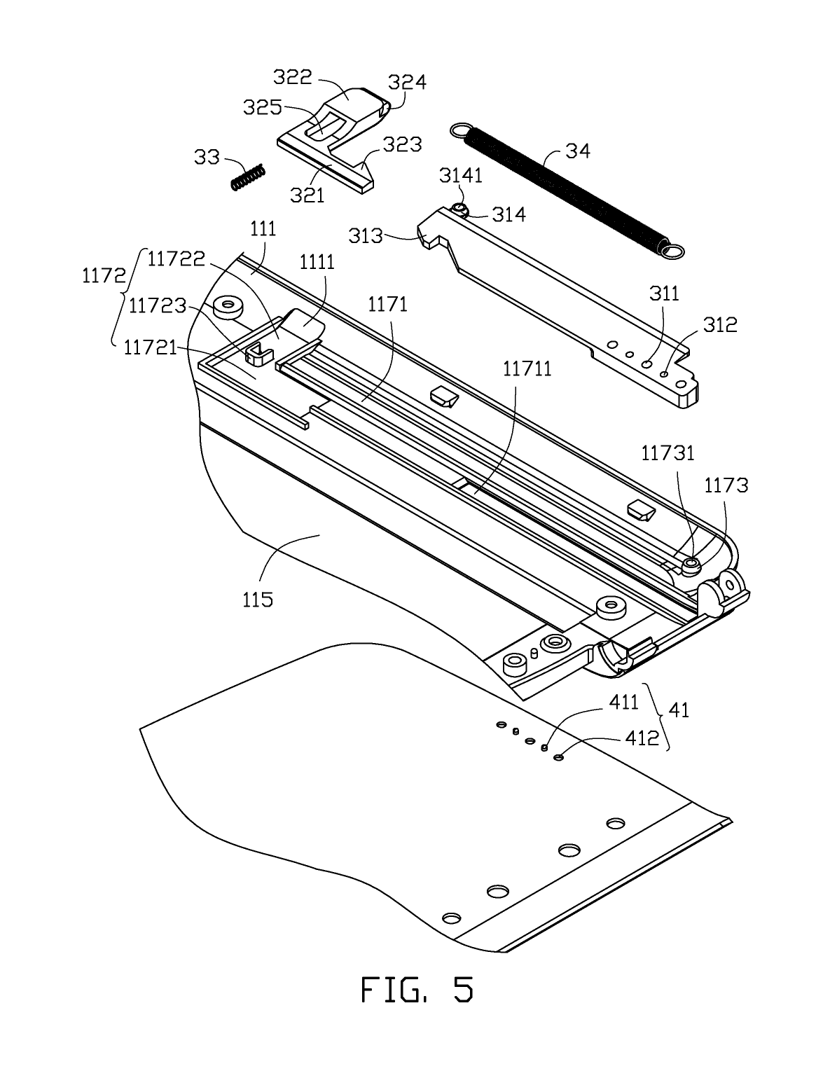

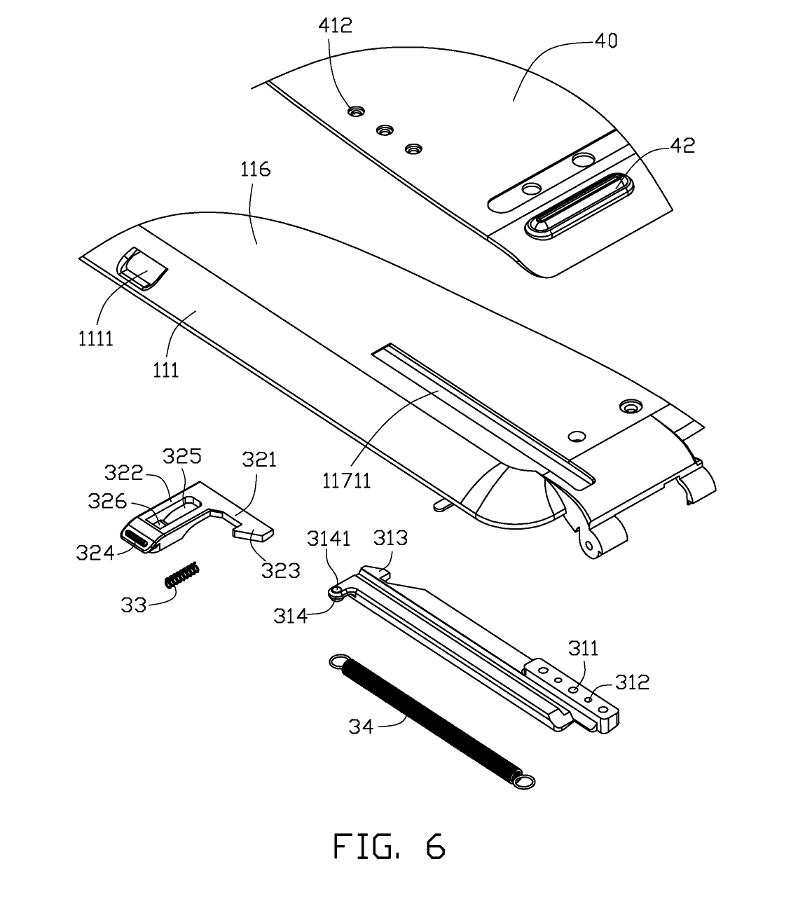

Referring to FIGS. 4-6, the base 10 includes a bottom case 11 and a top case 12 engaging with the bottom case 11. The bottom case 11 includes a main body 110, a first sidewall 111, a second sidewall 112 and a third sidewall 113. The main body 110 is substantially rectangular. The first sidewall 111, the second sidewall 112 and the third sidewall 113 extend towards the top case 12 from edges of the main body 110. The first sidewall 111 is opposite to the third sidewall 113. The second sidewall 112 is connected between the first sidewall 111 and the third side wall 113. A first through hole 1111 is defined at the center of the first sidewall 111, and a second through hole 1131 is defined at the center of the third sidewall 113 corresponding to the first through hole 1111. A pivoting edge 114 is located at a side of the main body 110 away from the second sidewall 112. The pivoting edge 114 pivotally connects the cover 20 to the base 10. The main body 110 includes an inner surface 115 facing the top case 12 and an outer surface 116 opposite to the inner surface 115. Two mounting portions 117 are symmetrically arranged on the inner surface 115, and respectively adjacent to the first sidewall 111 and the third sidewall 113.

Each mounting portion 117 includes a sliding groove 1171, an engaging groove 1172, and a first fixing portion 1173. The sliding groove 1171 is formed on the inner surface 115. The sliding groove 1171 is adjacent to the first sidewall 111 and is perpendicular to the pivoting edge 114. A length of the sliding groove 1171 is about one half of that of the first sidewall 111. The sliding groove 1171 defines a first opening 11711 at the bottom, passing through the inner surface 115 and the outer surface 116 perpendicularly. The engaging groove 1172 forms a recessed portion on the inner surface 115 adjacent to the first through hole 1111. The engaging groove 1172 is substantially L shaped. The engaging groove 1172 includes a first groove 11721 and a second groove 11722 perpendicularly connected to the first groove 11721 corresponding to the first through hole 1111. The first groove 11721 is parallel to the sliding groove 1171. The second groove 11722 defines a first stopping portion 11723 abutting the first groove 11721. The first stopping portion 11723 is a rib perpendicularly extending from the inner surface 115. The first stopping portion 11723 is substantially U shaped and has an opening towards the first through hole 1111. The first fixing portion 1173 is a protrusion post perpendicularly protruding from the inner surface 115 and arranged between the first sidewall 111 and the pivoting edge 114. The first fixing portion 1173 defines a first screw hole 11731.

The ejecting structure 30 includes a sliding member 31, an engaging member 32, a compression spring 33, and a tension spring 34. The sliding member 31 is substantially elongated and slidably located in the sliding groove 1171. The sliding member 31 defines a plurality of second screw holes 311 and a plurality of positioning holes 312 at one end, and defines a first hook 313 and a second fixing portion 314 at the other end. The second screw holes 311 and the positioning holes 312 alternate in a straight line. The second fixing portion 314 defines a third screw hole 3141. In the embodiment, the base 10 includes two ejecting structures 30 corresponding to the two mounting portions 117.

The engaging member 32 is arranged in the engaging groove 1172, and detachably engaged with the sliding member 31. The engaging member 32 is substantially “L”-shaped. The engaging member 32 includes a first arm 321 corresponding to the first groove 11721 and a second arm 322 corresponding to the second groove 11722. The first arm 321 is perpendicularly connected to the second arm 322. A width of the first arm 321 is smaller than that of the first groove 11721. A width of the second arm 322 is substantially the same to that of the second groove 11722. The first arm 321 defines a second hook 323 at one end away from the second arm 322 corresponding to the first hook 313. An operation portion 324 is arranged at one end of the second arm 322 away from the first arm 321. The second arm 322 defines a third through hole 325 corresponding to the first stopping portion 11723. The third through hole 325 is adjacent to the first arm 321. The second arm 322 defines a second stopping portion 326 recessed from a surface of the second arm 322. The second stopping portion 326 is located between the operating portion 324 and the third through hole 325.

The compression spring 33 is located between the first stopping portion 11723 and the second stopping portion 326. When a force is applied to the operation portion 324, the compression spring 33 is compressed and the engaging member 32 slides along the engaging groove 1172. At this time, the second stopping portion 326 moves towards the first stopping portion 11723 to further compress the compression spring 33, and the operation portion 324 is received in the bottom case 11. When the force applied to operation portion 324 is removed, the compression spring 33 recovers to expose the operation portion 324 out from the bottom case 11.

The tension spring 34 is fixed between the first fixing portion 1173 and the second fixing portion 314 by screws. When the first hook 313 engages with the second hook 323, the tension spring 34 is stretched. When the first hook 313 detaches from the second hook 323, the tension spring 34 recovers to drive the sliding member 31 towards the pivoting edge 114, to extend the stability plate 40 out of the bottom case 11.

The stability plate 40 is secured to the sliding member 31. The stability plate 40 is a substantially rectangular sheet. The stability plate 40 includes two third fixing portions 41 and two elastic supporting blocks 42. Each third fixing portion 41 includes a plurality of fourth through holes 411 corresponding to the second screw holes 311 and a plurality of positioning posts 412 corresponding to the positioning holes 312. The supporting block 42 is arranged on the surface of the stability plate 40 away from the outer surface 116 and adjacent to the third fixing portion 41.

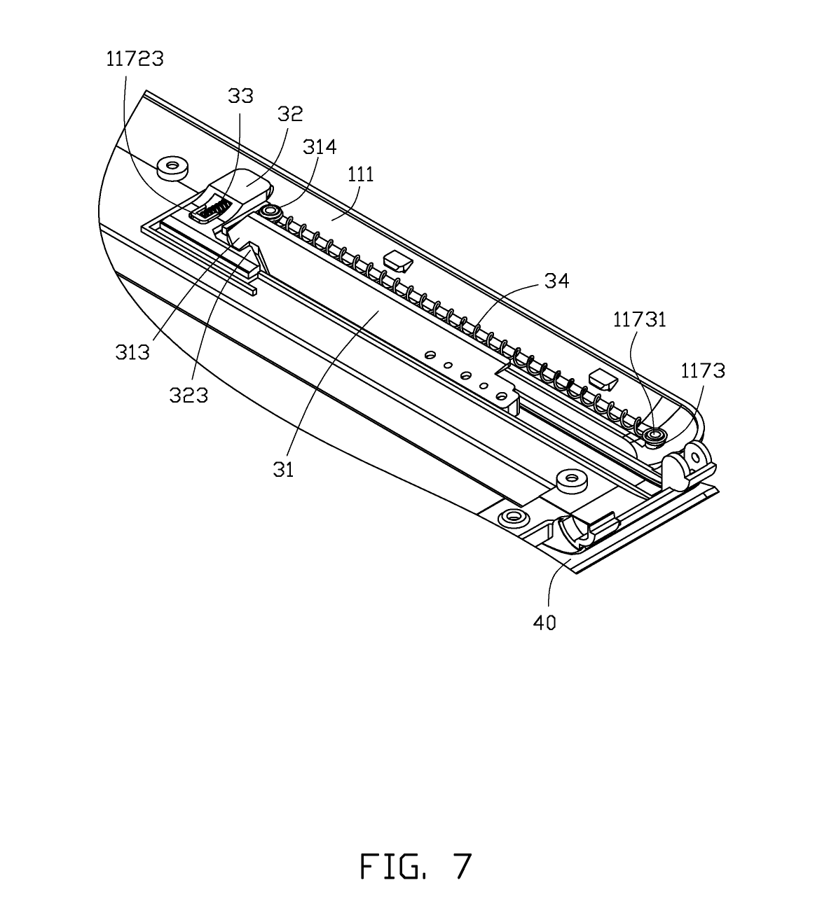

Referring to FIG. 7, in assembly, the sliding member 31 is first located in the sliding groove 1171. The stability plate 40 is secured to the sliding member 31 using screws through the fourth through hole 411, the first opening 11711, and the second screw hole 311. The tension spring 34 is secured between the first fixing portion 1173 and the second fixing portion 314 by screws. The engaging member 32 is arranged in the engaging groove 1172. Therefore, the first stopping portion 11723 can pass through the third through hole 325 to be exposed out of the second arm 322, and the operation portion 324 can pass through the first through hole 1111 to be exposed out of the bottom case 11. The compression spring 33 is arranged between the first stopping portion 11723 and the second stopping portion 326. The first hook 313 is engaged with the second hook 323 and the tension spring 34 is stretched to retain and hide the stability plate 40 within the bottom case 11.

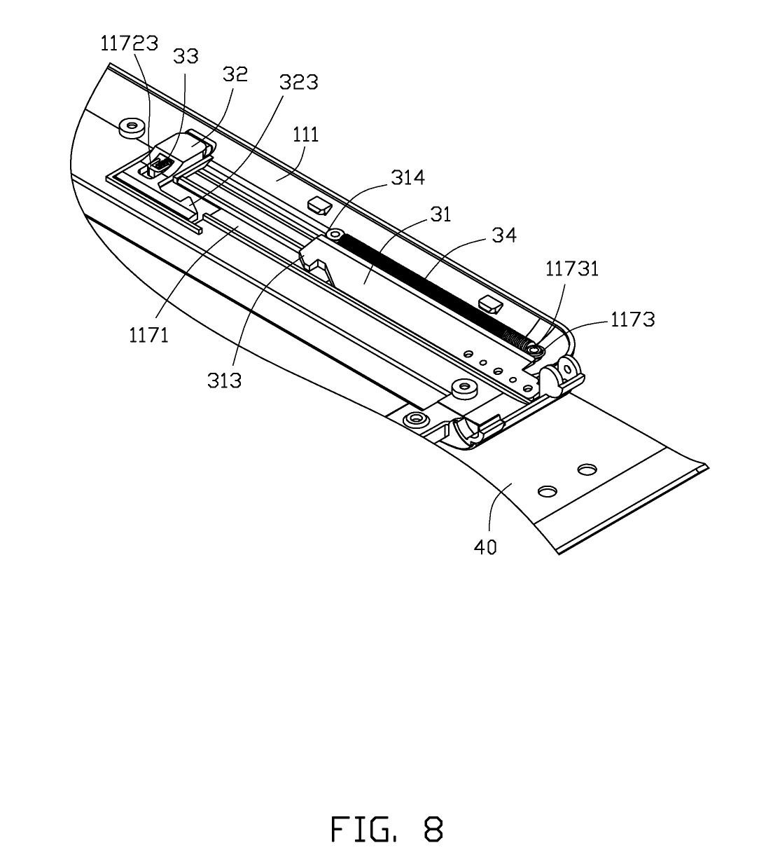

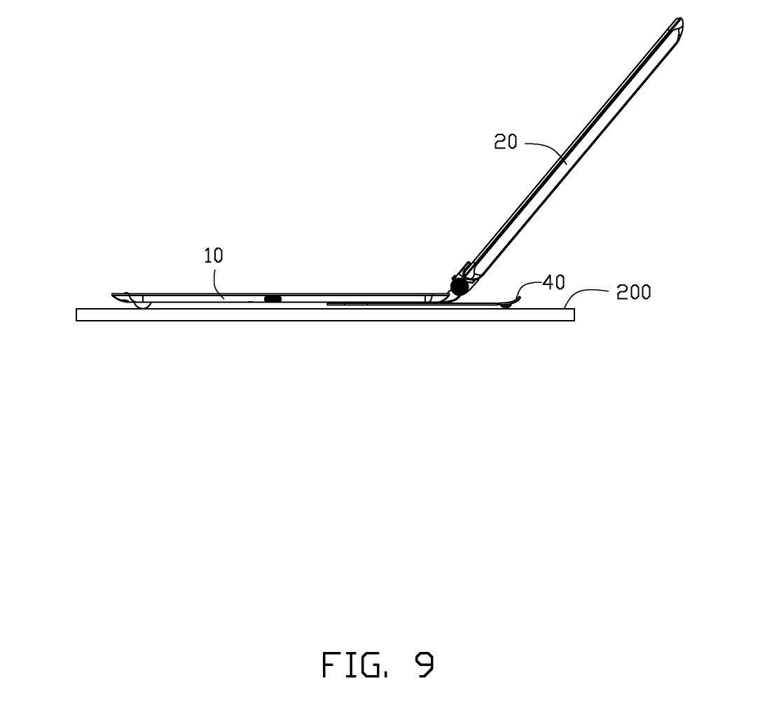

Referring to FIG. 8 and FIG. 9, when a force is applied to the operation portion 324, the compression spring 33 acts to detach the first hook 313 from the second hook 323. At this time, the stretched tension spring 34 is allowed to recover, to drive the sliding member 31 to slide towards the pivoting edge 114, to extend the stability plate 40 out of the bottom case 11. Thus, the stability plate 40 provides support to the folding electronic device 100 to prevent the base 10 from being overbalanced by the cover 20, even when the cover 20 is opened more than 90 degrees from the base 10.

It is to be understood, even though information as to, and advantages of, the present embodiments have been set forth in the foregoing description, together with details of the structures and functions of the present embodiments, the disclosure is illustrative only; and that changes may be made in detail, especially in the matters of shape, size, and arrangement of parts within the principles of the present embodiments to the full extent indicated by the broad general meaning of the terms in which the appended claims are expressed.

What is claimed is:

1. A folding electronic device, comprising:
a base;
a cover capable of being opened and closed relative to the base, the base comprising at least one ejecting structure; and
a stability plate assembled with the ejecting structure;
the stability plate is configured to eject in response to the cover relative to the base by the ejecting structure, and the ejected stability plate supports the folding electronic device.

2. The folding electronic device of claim 1, wherein the ejecting structure comprises a sliding member slidably arranged on the base, the stability plate is secured to the sliding member and is capable of sliding with the sliding member to eject from the base.

3. The folding electronic device of claim 2, wherein the base defines an engaging groove, the ejecting structure further comprises an engaging member slidably arranged in the engaging groove, and the engaging member is detachably engaged with the sliding member to hide the stability plate within the base.

4. The folding electronic device of claim 3, wherein the sliding member defines a first hook, the engaging member defines a second hook; the first hook is detachably engaged with the second hook.

5. The folding electronic device of claim 3, wherein the engaging member comprises an operating portion which extends from the base; the engaging member is configured to slide along the engaging groove to detach the engaging member from the sliding member.

6. The folding electronic device of claim 5, wherein a through hole is arranged on the base corresponding to the operating portion; a first stopping portion is arranged on the engaging groove; a second stopping portion is arranged on the engaging member corresponding to the first stopping portion; the ejecting structure further comprises an elastic member located between the first stopping portion and the second stopping portion; if a force is applied to the operating portion, the elastic member is deformed; if the force applied to operating portion is eliminated, the deformation of the elastic member is recovered to drive the operating portion to expose out from the base.

7. The folding electronic device of claim 5, wherein the ejecting structure further comprises a tension spring fixed between the sliding member and the base; if the engaging member engages with the sliding member, the tension spring is pulled to deform; if the engaging member detaches from the sliding member, the deformation of the tension spring is recovered to drive the sliding member to slide towards the base to eject the stability plate out of the base.

8. The folding electronic device of claim 1, wherein a supporting block is arranged on the stability plate to support the folding electronic device together with the base.

9. The folding electronic device of claim 1, wherein the folding electronic device comprises two ejecting structures symmetrically arranged on the base.

10. A housing for a folding electronic device, the folding electronic device comprising a cover, the housing comprising:
a base,
at least one ejecting structure located in the base; and
a stability plate fixed on the ejecting structure;
wherein the ejecting structure comprises an operating portion exposed out of the base, if the operating portion is pressed, the stability plate is ejected out from the base by the ejecting structure to support the folding electronic device.

11. The housing of claim 10, wherein the ejecting structure further comprises a sliding member slidably arranged on the base, the stability plate is secured to the sliding member and is capable of sliding with the sliding member to be ejected out from the base.

12. The housing of claim 11, wherein the base further comprises an engaging groove, the ejecting structure further comprises an engaging member slidably arranged within the engaging groove, and the engaging member is detachably engaged with the sliding member to receive the stability plate within the base.

13. The housing of claim 12, wherein the sliding member defines a first hook, the engaging member defines a second hook; the first hook is detachably engaged with the second hook.

14. The housing of claim 12, wherein the operating portion is located on the engaging member and be exposed from the base; if the operating portion is pressed, the engaging member slides along the engaging groove to detach the engaging member from the sliding member.

15. The housing of claim 14, wherein a through hole is arranged on the base corresponding to the operating portion; a first stopping portion is arranged on the engaging groove; a second stopping portion is arranged on the engaging member corresponding to the first stopping portion; the ejecting structure further comprises an elastic member located between the first stopping portion and the second stopping portion; if a force is applied to the operating portion, the elastic member is deformed; if the force applied to operating portion is eliminated, the deformation of the elastic member is recovered to drive the operating portion to expose out from the base.

16. The housing of claim 14, wherein the ejecting structure further comprises a tension spring fixed between the sliding member and the base; if the engaging member engages with the sliding member, the tension spring is pulled to deform; if the engaging member detaches from the sliding member, the deformation of the tension spring is recovered to drive the sliding member to slide towards the base to eject the stability plate out of the base.

17. The housing of claim 10, wherein a supporting block is arranged on the stability plate to support the folding electronic device together with the base.

18. The housing of claim 10, wherein the base comprises two ejecting structures symmetrically arranged on the base.
